(19) United States
(12) Patent Application Publication
(10) Pub. No.: US 2006/0196438 A1
(43) Pub. Date: Sep. 7, 2006

(54) Litter box organizer system

(75) Inventors: Elif Caputa, Boca Raton, FL (US); Brooke Sloate, Weston, FL (US); Michael J. Otterman, Maumee, OH (US); Anthony M. DeMore, New York, NY (US)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: H.P. Intellectual Corp.

(21) Appl. No.: 11/072,759

(22) Filed: Mar. 4, 2005

(51) Int. Cl. A01K 29/00

(52) U.S. Cl. 119/165

(57) ABSTRACT

Embodiments of the present invention generally relate to a pet litter organizer apparatus. In accordance with one embodiment, a receptacle for holding pet litter is provided. The receptacle has a base, a peripheral wall extending from the base, and an interior volume for receiving pet litter. The embodiment also includes a litter passage formed in the peripheral wall and configured to permit dispensing of pet litter from the interior volume through the litter passage. Additionally, the embodiment includes a dispensing mechanism movably coupled to the litter passage. The dispensing mechanism is adapted to regulate the flow of pet litter from the interior volume through the litter passage.

### BACKGROUND

The present invention relates generally to pet accessories and, more particularly, to an organizational system for a pet litter box.

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Domestication of animals originated millennia ago. Archeologists have discovered evidence that dogs were first domesticated circa 5000 B.C. to assist people in hunting for food. Although domestication of cats occurred later in history, cats were domesticated, and even revered, in ancient Egypt over three thousand years ago. Indeed, Egypt had a feline goddess and all cats were considered to be demigods. While pets may not enjoy quite the same status today, these pets are a source of joy and companionship for hundreds of millions of people worldwide. In some cases, pets are regarded as a member of the family by their owners.

However, there are disadvantages associated with having any pet. While many people feel that these disadvantages do not outweigh the concomitant benefits of owning a pet, these disadvantages are not inconsequential. For instance, certain financial costs are incurred by many pet owners, including the purchase of food, toys, accessories, and in the case of many animals, veterinarian bills. In addition to these financial costs, owning a pet also typically requires a substantial expenditure of time and effort to care for the pet. This time and effort may be spent in a wide range of activities that vary depending on the pet. Such activities generally include feeding the pet, and may also include walking the pet, grooming the pet, and, unfortunately, disposing of pet waste.

Many animals, such as cats, may be advantageously trained to use a pan or box containing pet litter. While a litter box reduces the frequency with which waste must be disposed by the owner, it does not eliminate the chore. First, the litter pan must be filled with litter. However, as many pet owners would appreciate most of the boxes and bags in which pet litter is sold are not well suited for dispensing a particular amount of litter. These litter containers can easily slip from an owner's grasp, causing pet litter to spill onto the floor. Further, the weight of these original containers can shift during dispensing of the litter, also resulting in litter spilled on the floor about the litter pan. Then, on a regular basis, the litter box has to be emptied of soiled pet litter and refilled with fresh pet litter. However, emptying the pet litter box is often worse than filling it. In addition to the odor associated with the soiled litter, the full litter box is often heavy, making it difficult to lift the litter box, hold open a disposal bag, and pour the contents of the litter box into the bag. Finally, the litter box has to be re-filled with fresh pet litter, which may again result in litter spilling on the floor about the pet litter box.

To reduce the frequency with which the litter needs to be changed, scoopable pet litter has been developed and is available on the market. This type of pet litter is ordinarily formulated to clump about pet waste in the litter pan, allowing pet owners to remove the clumps from the litter box with a scoop. While this may reduce odors by removing the pet waste and heavily soiled litter, such litter does not ameliorate all of the inconveniences associated with a litter box. First, scooping waste from the litter box reduces the amount of litter remaining in the litter box. Consequently, as waste is removed from the litter pan, fresh litter must be frequently added to the litter pan to maintain maximum effectiveness. As discussed above, pouring pet litter into the litter box often leads to stray litter on the ground, requiring even further effort to clean. Additionally, using scoopable pet litter requires a pet owner to purchase multiple pet litter accessories, including a litter scoop and disposal bags.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Embodiments of the present invention generally provide a litter box organization apparatus and system. In one embodiment, a receptacle for holding pet litter is provided. In general terms, the receptacle has an interior volume for storing pet litter. In this embodiment, a litter passage is formed in the receptacle and is configured to permit pet litter to pass from the interior volume through the passage. The embodiment also includes a dispensing mechanism movably coupled to the litter passage. The dispensing mechanism is capable of regulating the flow of pet litter from the interior volume through the litter passage. Alternative embodiments may also include a litter pan for receiving pet litter dispensed from a litter receptacle and a base section capable of both receiving the litter pan and being coupled to the litter receptacle. Further, methods of operating and manufacturing such an apparatus are also provided.

### BRIEF DESCRIPTION OF THE DRAWINGS

Advantages of the invention may become apparent upon reading the following detailed description and upon reference to the drawings in which:

FIG. 1A is a perspective view of an exemplary litter organizer system having a litter storage bin in accordance with the present techniques;

FIG. 1B is a perspective view illustrating an alternative placement of an air freshener of the exemplary litter organizer system depicted in FIG. 1 in accordance with the present techniques;

FIG. 1C is a plan view of the air freshener and that portion of the exemplary litter organizer system illustrated in FIG. 1B;

FIG. 2 is a perspective view of the base section and litter pan of the exemplary litter organizer system illustrated in FIG. 1;

FIG. 3 is a perspective view of the storage bin of the exemplary litter organizer system illustrated in FIG. 1;

FIG. 4A is a further perspective view of the exemplary storage bin illustrated in FIG. 3, depicting additional features of the storage bin;

FIG. 4B is a magnified view of the area indicated in FIG. 4A, showing additional features of a storage bin in accordance with an embodiment of the present invention:

FIG. 5A is a front elevational view of an exemplary air freshener that may be employed with a litter organizer system in accordance with the present techniques;

FIG. 5B is a side elevational view of the exemplary air freshener depicted in FIG. 5A;

FIG. 5C is a bottom plan view of the exemplary air freshener depicted in FIGS. 5A and 5B;

FIG. 6 is a perspective view illustrating operation of the exemplary litter organizer system shown in FIG. 1; and

FIG. 7 is a perspective view of the exemplary litter organizer system of FIG. 1 illustrating an exemplary compact arrangement of the system.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

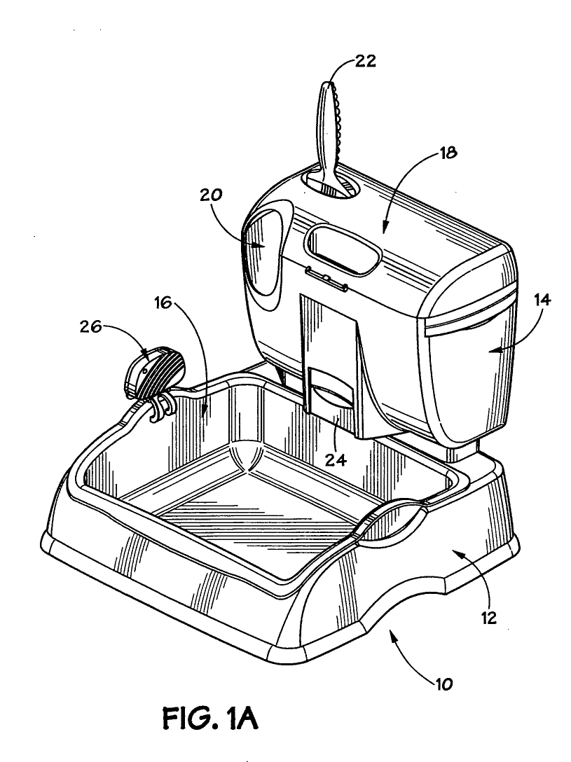

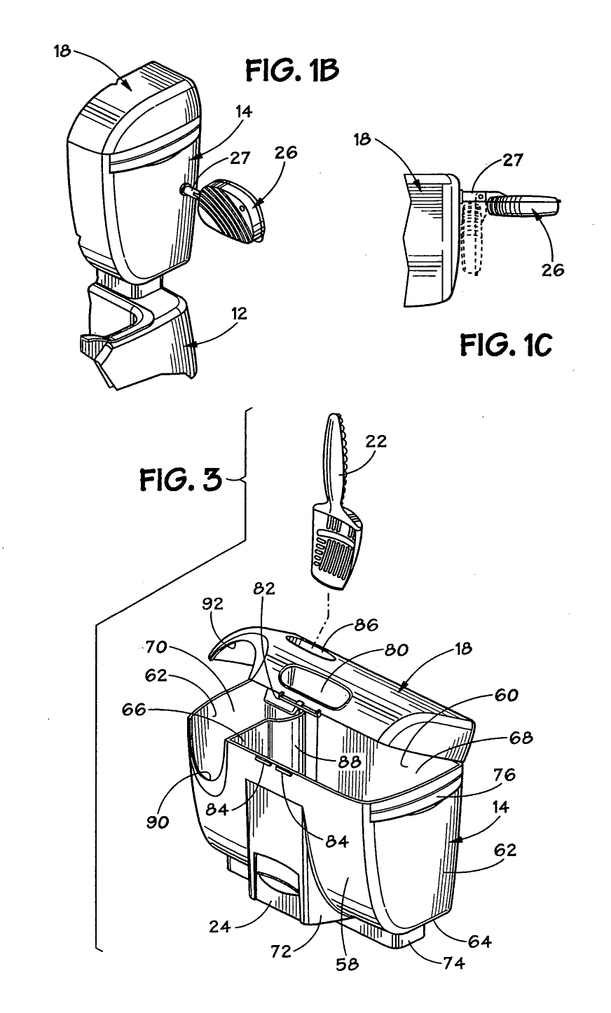

Turning now to the drawings, FIG. 1 illustrates an exemplary pet litter organizer system in accordance with the present techniques. The exemplary system may generally be referred to as the system or organizer 10. The organizer 10 includes a base section 12, a storage bin 14, and a removable litter pan 16. As discussed in greater detail below in reference to FIG. 3, the storage bin 14 may include one or more storage volumes accessible via a lid 18 and/or an aperture 20 of the storage bin 14. Moreover, the lid 18 may be configured to hold a litter scoop 22.

The base section 12, the storage bin 14, the litter tray 16, and the scoop 22 may be constructed of various materials. These components of the organizer 10 may be made of one or more durable materials that are easily cleaned, such as plastic. In one embodiment, these components also include a non-stick surface to permit easy cleaning of the components. However, other materials may be used in accordance with the present techniques. Further, the organizer system 10 may be formed in various shapes. Such shapes may be dictated by functionality and/or to improve aesthetic qualities of the system 10.

As will be discussed in further detail below, the exemplary storage bin 14 also includes a door 24 to permit the dispensing of pet litter from the storage bin 14 to the litter pan 16. This configuration allows for pet litter to be poured into the storage bin 14 and occasionally dispensed into the litter pan 16. As may be appreciated, pet litter typically is sold in boxes or bags of various weights and sizes. Often, these bags and boxes are unwieldy, and it can be difficult to pour a discrete amount from the bag or box into a litter pan. Thus, the organizer 10 is much more convenient for a pet owner. The owner can fill the storage bin 14 with a large amount of litter and then easily dispense the desired amount of pet litter into the litter pan 16, without the hassle of lifting and pouring from the original container every time more pet litter is desired.

Additionally, an air freshener 26 also may be provided. In the embodiment illustrated in FIG. 1A, the air freshener 26 is secured to a side of the litter pan 16. However, as may be seen in FIGS. 1B and 1C, the air freshener 26 also may be positioned at a side of storage bin 14 or some other location of the organizer 10, such as the base section 12. In FIG. 1B, the air freshener 26 is shown coupled via a hinge 27 to the storage bin section 14. In addition to coupling the air freshener 26 to the storage bin 14, the hinge 27 also permits rotational movement of the air freshener 26, as shown in FIG. 1C. This movement allows the air freshener 26 to be folded against the storage bin 14 to permit the nesting of the storage bin 14 in the litter pan 16, as discussed below with respect to FIG. 7.

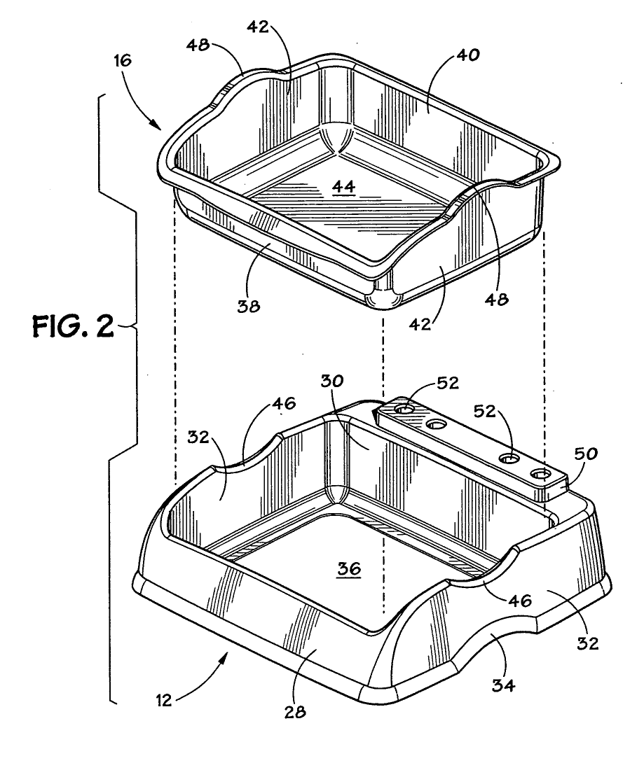

A perspective view of the base section 12 and the removable litter pan 16 is illustrated in FIG. 2. As may be seen in the illustrated embodiment, the base section 12 includes a front wall 28, a rear wall 30, and side walls 32. Further, in this particular embodiment, the side walls 32 also include contoured handles 34 for lifting the base section 12. The walls 28, 30, and 32 generally define an inner cavity 36 adapted to receive the litter pan 16.

The litter pan 16 of the exemplary organizer 10 includes a front wall 38, a rear wall 40, side walls 42, and a bottom surface 44. These walls 38, 40, and 42, in addition to the bottom surface 44, allow the litter pan 16 to receive and contain a quantity of pet litter. Advantageously, the walls 38, 40, and 42 are of sufficient height (such as five inches) to accommodate a three-inch layer of pet litter within the litter pan 16 to reduce penetration of pet waste to the bottom surface 44. However, at least one of the walls, such as front wall 38, may be lower in height, such as four inches, to allow pets to enter and exit the litter pan 16 easily. The side walls 42 of the exemplary litter pan 16 also include handles 48. The handles 48 may be helpful in inserting and removing the litter pan 16 from the cavity 36 of the base section 12. While the handles 48 are formed integrally with the litter pan 16 in the illustrated embodiment, the handles could instead be formed separately and then be coupled to the litter pan 16. Further, the base section 12 also includes indentations 46, which are positioned proximate to the handles 48 when the litter pan 16 is inserted into the cavity 36, to allow greater access to the handles 48. Finally, in the particular embodiment illustrated in FIG. 2, an attachment surface 50 of the base section 12 is provided. This attachment surface 50 includes a plurality of apertures 52 for receiving mating features of the storage bin 14 to couple the base section 12 to the storage bin 14, as will be discussed in detail below.

The bin section 14 of the exemplary organizer system 10 is depicted in greater detail in FIG. 3. In the illustrated embodiment, the storage bin 14 generally includes a front wall 58, a rear wall 60, side walls 62, and a bottom surface 64, which define an inner volume for storing pet litter and pet accessories. In the presently illustrated embodiment, the bin section 14 is translucent to allow the contents of the inner volume, including the amount of pet litter remaining in the bin section 14, to be viewed. In the illustrated embodiment, an inner wall 66 divides the volume defined by the walls 58, 60, and 62, and bottom surface 64, into two cavities 68 and 70. The cavity 68 is adapted to receive and contain pet litter, while the cavity 70 is configured to store additional pet litter accessories. For instance, the cavity 70 may be used to store pet litter disposal bags, which may simply be plastic grocery bags, for disposing of pet waste scooped from the litter pan 16. Moreover, the cavity 70 is capable of containing a variety of other pet accessories. For example, these additional pet accessories may include pet litter pan liners pet brushes, pet toys, or any other such accessory.

As discussed below, pet litter may be dispensed from the cavity 68 to the litter pan 16 via a litter passage, such as litter chute or spout 72, by opening the door 24 of the storage bin 14, which is slidably coupled to the storage bin 14 in the present embodiment. The location of the litter passage, such as spout 72, proximate the bottom of the storage bin 14 permits gravity to force litter through the litter passage. Also, the location of the litter passage on a side of the storage bin 14 permits the litter passage to be positioned close to the litter pan 16, without inhibiting a pet from entering or exiting the litter pan 16. Further, while the illustrated bin section 14 has a generally rectangular profile, other shapes are also envisaged in accordance with the present techniques. For instance, in other embodiments, the bin section 14 may instead have a generally cylindrical shape or some other desirable shape.

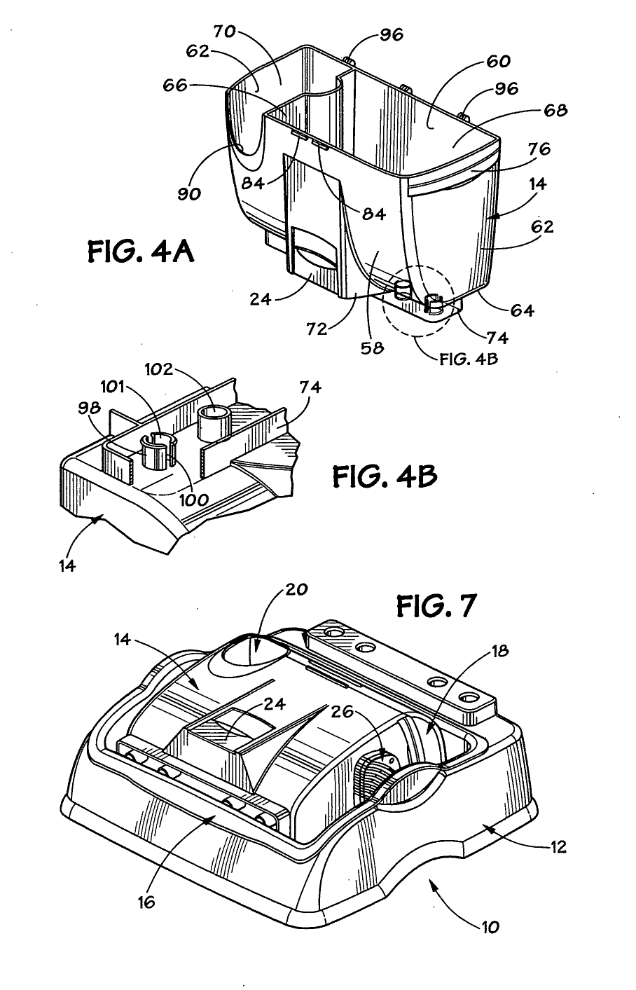

The bottom surface 64 of the storage bin 14 also may include a flange 74 configured to mate with the attachment surface 50 of the base section 12 illustrated in FIG. 2. Coupling of the base section 12 and the storage bin 14 via the attachment surface 50 will be discussed in greater detail below with respect to FIGS. 4A and 4B. Handles 76 are also provided on the side walls 62 of the exemplary storage bin 14. These handles 76 allow for easy positioning and movement of storage bin 14 and may also aid in assembly of the organizer 10.

As discussed above, the storage bin 14 includes a lid 18. The lid 18 permits access to the inner storage volumes or cavities of storage bin 14, such as the cavities 68 and 70 discussed above. As shown in the present figure, the lid 18 may include a handle 80 to assist in opening and closing the lid. Further, the lid 80 and the storage bin 14 may include latching members 82 and 84, respectively, for preventing inadvertent opening of the lid 80. Still further, the lid 80 also may include a recess 86 for receiving and holding the litter scoop 22. Accordingly, the inner wall 66 includes a recessed portion 88 to permit the portion of the lid 80 defining the recess 86 to fit within the cavity 70 when the lid 80 is closed. Additionally, the exemplary storage bin 14 includes indentations 90 and 92, formed in the front wall 58 and the lid 80 respectively, to permit access to the accessory cavity 70 even when the lid 80 is closed.

Additional features of the storage bin 14 are illustrated in FIGS. 4A and 4B. In particular, these figures are helpful in depicting various attachment features of the storage bin 14. In FIG. 4A, the storage bin 14 is illustrated without the lid 18 to permit hinges 96 to be illustrated. The hinges 96 are included on the rear wall 60 of the storage bin 14 to allow coupling of the lid 18 to the storage bin 14. Further, coupling features, such as a locking post 98 and a guide post 102 as discussed below, are also illustrated on the bottom surface 64 of the storage bin 14. These posts 98 and 102 permit coupling of the storage bin 14 to the base section 12. A more detailed view of posts 98 and 102 is provided in FIG. 4B. It should be noted, however, in an alternative embodiment, the storage bin 14 is configured to allow mounting of the storage bin 14 on a wall proximate to the base section 12.

In FIG. 4B, the lower portion of the storage bin 14 is illustrated. A section of the flange 74 is cut away to allow the detailed features of posts 98 and 102 to be clearly depicted. In this embodiment, the flange 74 is adapted to fit around the attachment surface 50 of the base section 12. Further, a locking post 98 and a guide post 102 are provided on each end of the bottom surface 64 of the storage bin 14. The locking posts 98 and guide posts 102 are adapted to mate with the apertures 52 of the base section 12 to aid in proper alignment and assembly of the storage bin 14 and the base section 12.

The locking posts 98 additionally may prevent inadvertent uncoupling of the base section 12 and the storage bin 14 once assembled. To facilitate this additional functionality, a slit 100 allows compression of each locking post 98 upon insertion of the locking post 98 into the respective aperture 52. Each locking post 98 includes a lip 01 that, in an uncompressed state, defines an outer diameter greater than the diameter of a respective aperture 52. The compression of the locking post 98 causes the outer diameter of the lip 101 to decrease, permitting insertion of the locking post 98 into an aperture 52. However, once inserted through the aperture 52, the locking post 98 returns to its uncompressed form. As a result of this resiliency, the outer diameter of the lip 101 expands to its ordinary, uncompressed state. Moreover, once the locking post 98 is inserted into the aperture 52 and the outer diameter of the lip expands, the lip 101 cooperates with a portion of the attachment surface 50 proximate the aperture 52 to prevent inadvertent removal of the storage bin 14 from the base section 12. For example, the locking posts 98 may prevent the storage bin 14 from uncoupling from the base section 12 upon contact by a pet or when being moved by a person. However, as may be appreciated, a sufficient upward force may be applied to the storage bin 14 to cause compression of locking post 98 and uncoupling of the storage bin 14 from the base section 12 without damaging the system 10. Thus, the storage bin 14 may be removed from the base section 12 for easier cleaning or transport of the system 10.

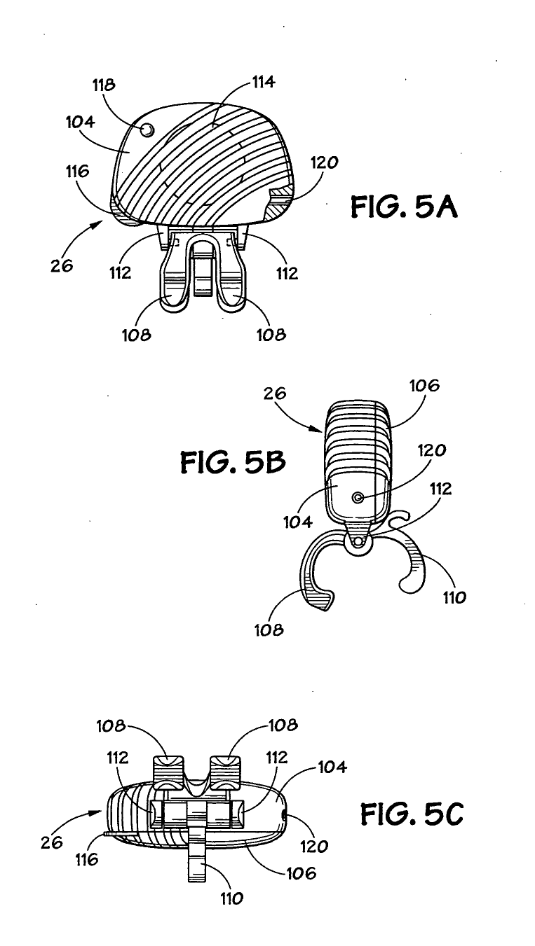

Details regarding the air freshener 26 may be more clearly understood with reference to FIGS. 5A-5C. As may be seen in these figures, the exemplary air freshener 26 includes a front housing shell 104 and a rear housing shell 106. In the present embodiment, the bottoms of housing shells 104 and 106 are wider than the tops, providing increased stability when mounted to the organizer 10. Further, the air freshener 26 also includes front clips 108 and a rear clip 110 to allow attachment of the air freshener 26 to the litter pan 16 as illustrated in FIG. 1A. Moreover, rubber pads may be affixed to the clips 108 and 110 to prevent sliding or slipping of the air freshener 26 when mounted on the organizer 10. While the present embodiment uses two front clips 108 and one rear clip 110 to secure the air freshener 26 to a portion of the organizer 10, it should be appreciated that other clip configurations are possible. Indeed, other coupling arrangements beside clips may be used, such as the hinge 27 of FIGS. 1B and 1C, in accordance with the present techniques. As may also be seen in the present illustrations, a hinge assembly 112 allows coupling of the clips 108 and 10 to the main body of the air freshener 26.

The various external components of the air freshener 26, including housing shells 104 and 106, the front clips 108, the rear clip 110, and the hinge assembly 112, may be made of a rugged, durable material that is also easy to clean, such as plastic. The air freshener 26 also may have a non-stick surface that allows easier cleaning of the device.

The housing shells 104 and 106 may also include an aperture 114 to allow air to flow through the air freshener 26. Accordingly, a fan (not shown) may be provided within the air freshener 26 to promote such airflow. A tab 116 is also shown extending from the rear housing shell 106 to allow opening of the air freshener 26 for access to inner components. These inner components could include the fan mentioned above, as well as any cleaning element. In this embodiment, the cleaning element is capable of reducing ammonia concentration associated with pet waste in the litter pan 16. For example, a carbon filter may be used. In an alternative embodiment, the cleaning element is an ionic generator. Though the tab 116 is shown extending from the rear housing shell 106 in the present figures, it should be understood that the tab 116 could easily extend from the front housing shell 104 instead, while providing the same functionality.

A power indicator, such as an LED 118, also may be provided to indicate operation of the air freshener 26. In the present embodiment, the LED 118 is provided on the front housing shell 10, though other locations may be used in accordance with the present techniques. Additionally, the air freshener 26 may be powered in a variety of manners. This power may be employed to actuate internal components of the air freshener 26, such as a fan or ionic generator. For example, a power inlet 120 may be provided to receive external power. The air freshener 26 may be adapted to receive DC power from an AC adapter through the power inlet 120. However, other types of power may be utilized, such as that provided by an internal battery.

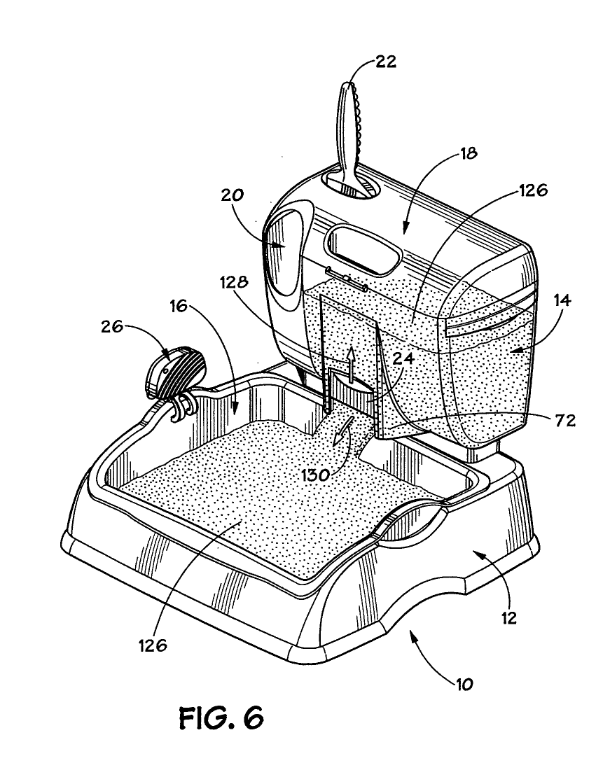

Turning now to FIG. 6, the organizer system 10 is depicted with a quantity of pet litter 126. As described above, the storage bin 14 and the litter pan 16 are adapted to receive and contain pet litter 126. However, as pet waste is removed from the litter pan 16, such as via the scoop 22, the amount of pet litter 126 in the litter pan 16 is reduced. Accordingly, as discussed above, the door 24 permits dispensing of a quantity of pet litter 126 from the storage bin 14 to the litter pan 16. In particular, the door 24 of the storage bin 14 may be moved generally upwardly, in the direction shown by arrow 128, from its closed position to an open position to permit dispensing of the pet litter 126 from the storage bin 14 to the litter pan 16. Moreover, upwardly sliding the door 24 allows gravity to force an amount of pet litter 126 through the spout 72, as generally indicated by arrow 130.

Additionally, the general contours of the various components of the organizer system 10 allow for nesting of the components, as illustrated in FIG. 7. As discussed above, the litter pan 16 is adapted to fit within the base section 12. Further, in the arrangement depicted in FIGS. 1B and 1C, the air freshener 26 may be folded against a side of the storage bin 14 to reduce the aggregate profile of these two components. The storage bin 14 then may be nested inside the litter pan 16. As discussed above, the litter pan 16 is configured to fit within the base section 12. This nested arrangement offers several benefits, including providing a compact shape, which allows easier storage and transportation of the organizer 10.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1-9. (canceled)

10. A system for organizing a pet litter box and pet accessories, the system comprising:
a bin section adapted to store and dispense pet litter, the bin section comprising:
exterior walls and an inner wall that divides an interior of the bin section into a litter cavity and an accessory cavity, wherein the litter cavity holds pet litter and the accessory cavity holds pet accessories; and
a dispensing mechanism comprising an aperture in a wall of the litter cavity and a door movably coupled to the bin section adjacent the aperture, the dispensing mechanism adapted to selectively permit dispensing of pet litter from the litter cavity;
a litter pan configured to receive pet litter dispensed from the bin section; and
a base section adapted to receive the litter pan, wherein the bin section and the base section are configured to be coupled to each other.

11. The system of claim 10, wherein the bin section and the base section are configured to be removably coupled to each other.

12. The system of claim 10, wherein the bin section comprises a litter chute configured to permit passage of pet litter from the aperture of the litter receptacle to the litter pan.

13. The system of claim 10, comprising an air freshener.

14. The system of claim 13, wherein the air freshener comprises a plurality of mounting clips.

15. The system of claim 13, wherein the air freshener is hingedly coupled to one of the bin section or base section, wherein the air freshener is foldable against a side of one of the bin section or base section, whereby the aggregate profile of the coupled components is reduced when the air freshener is folded.

16. A system for organizing a pet litter box and pet accessories, the system comprising:
a bin section adapted to store and dispense pet litter, the bin section comprising:
a litter receptacle for holding pet litter, the litter receptacle having an aperture; and
a dispensing mechanism movably coupled to the litter receptacle adjacent the aperture, the dispensing mechanism adapted to selectively permit dispensing of pet litter from the litter receptacle;
a litter pan configured to receive pet litter dispensed from the bin section; and
a base section adapted to receive the litter pan, wherein the bin section and the base section are configured to be coupled to each other, wherein the bin section, the base section, and the litter pan are nestable.

17. The system of claim 10, wherein the bin section is translucent.

18. A method for manufacturing a pet litter organizer system, the method comprising:
configuring a bin section to store pet accessories, the bin section comprising an accessories cavity for holding pet accessories;
configuring the bin section to store and dispense pet litter, the bin section comprising a litter cavity for holding pet litter, the litter cavity comprising an aperture adapted to dispense pet litter;
providing a dispensing mechanism adjacent the aperture; and
coupling a base section to the bin section and configuring the base section to receive the litter pan; and
configuring the litter pan to receive pet litter dispensed from the bin section when the litter pan is received in the base section.

19. The method of claim 18, wherein the bin section, the litter pan, the base section, and the dispensing mechanism are plastic.

20. The method of claim 18, comprising providing a lid on the bin section.

21. The system of claim 16, wherein the bin section, the base section, and the litter pan being nestable comprises the bin section being detachable from the base section.

22. The system of claim 16, wherein the bin section, the base section, and the litter pan being nestable comprises the bin section being insertable into the base section.

23. The system of claim 16, wherein the bin section, the base section, and the litter pan being nestable comprises the bin section being detachable from the base section and insertable into the litter pan.
